(19) United States
(12) Patent Application Publication
(10) Pub. No.: US 2009/0289878 A1
(43) Pub. Date: Nov. 26, 2009

(54) LIQUID CRYSTAL DISPLAY DEVICE AND DRIVING METHOD THEREOF

(76) Inventor: Chung-Chun Chen, Hsin-Chu (TW)

Correspondence Address: NORTH AMERICA INTELLECTUAL PROPERTY CORPORATION, P.O. BOX 506, MERRIFIELD, VA, 22116, US

(21) Appl. No.: 12/168,149

(22) Filed: Jul. 6, 2008

(30) Foreign Application Priority Data
May 22, 2008 (TW) 097118866

(51) Int. Cl. G09G 3/36

(52) U.S. Cl. 345/87

(57) ABSTRACT

An LCD device and driving method thereof are disclosed. The LCD device includes a source driver, a controller, a voltage generator, a plurality of data lines, a plurality of pixels, and a plurality of demultiplexer modules. The controller provides two sets of control signals. The voltage generator provides an AC common voltage. Each demultiplexer module includes two demultiplexers. The first demultiplexer distributes data signals received from the source driver into a set of data lines based on the first set of control signals. The second demultiplexer distributes data signals received from the source driver into another set of data lines based on the second set of control signals. The driving method is utilized for writing a plurality of low-voltage data signals having different polarities into a plurality of pixels based on different common voltages during different intervals of a frame period.

### BACKGROUND OF THE INVENTION

1. Field of the Invention

The present invention relates to a liquid crystal display device and driving method thereof, and more particularly, to a liquid crystal display device based on the dot-inversion or pixel-inversion driving operation with low-voltage data signals and driving method thereof.

2. Description of the Prior Art

Because liquid crystal display (LCD) devices are characterized by thin appearance, low power consumption, and low radiation, LCD devices have been widely applied in various electronic products for panel displaying. In general, the LCD device comprises liquid crystal cells encapsulated between two substrates and a backlight module for providing lighting source. The operation of an LCD apparatus is featured by varying voltage drops between opposite sides of the liquid crystal cells for twisting the angles of the liquid crystal molecules of the liquid crystal cells so that the transparency of the liquid crystal cells can be controlled for illustrating images with the aid of the backlight module.

It is well known that the polarity of voltage drop across opposite sides of the liquid crystal cells should be inverted periodically for protecting the liquid crystal cells from causing permanent deterioration due to polarization, and also for reducing image sticking effect on the LCD device. In general, the LCD panel driving operations can be categorized into the frame-inversion driving operation, the line-inversion driving operation, the pixel-inversion driving operation, and the dot-inversion driving operation.

While driving an LCD device based on the frame-inversion driving operation, the polarities of data applied to each liquid crystal cell are inverted with respect to alternating display frames. The line-inversion driving operation comprises the column-inversion driving operation and the row-inversion driving operation. While driving an LCD device based on the column-inversion driving operation, the polarities of data applied to each liquid crystal cell are inverted with respect to alternating data lines. While driving an LCD device based on the row-inversion driving operation, the polarities of data applied to each liquid crystal cell are inverted with respect to alternating gate lines. While driving an LCD device based on the pixel-inversion driving operation, data signals having opposite polarities are applied to adjacent pixel units, and the data signals of the red, green, and blue sub-pixel units in the same pixel unit have the same polarity. While driving an LCD device based on the dot-inversion driving operation, data signals having opposite polarities are applied to adjacent sub-pixel units. Among the aforementioned LCD panel driving operations, the pixel-inversion driving operation and the dot-inversion driving operation are well known to provide better display quality. In view of that, recently LCD panels have mainly used the pixel-inversion driving operation or the dot-inversion driving operation for displaying images.

Please refer to FIG. 1, which is a schematic diagram showing a prior-art LCD device based on the dot-inversion driving operation. As shown in FIG. 1, the LCD device 100 comprises a source driver 110, a control circuit 120, a gate driver 130, a demultiplexer unit 140, a plurality of data lines 160, a plurality of gate lines 150, and a plurality of pixel units 170. The demultiplexer unit 140 comprises a plurality of demultiplexers 145. For ease of explanation, two demultiplexers DUX11 and DUX12 are shown in FIG. 1. The demultiplexer DUX11 comprises three switches SWR1, SWG1 and SWB1. Also, the demultiplexer DUX12 comprises three switches SWR2, SWG2 and SWB2. Each pixel unit 170 comprises a red sub-pixel unit 175, a green sub-pixel unit 176 and a blue sub-pixel unit 177. Each sub-pixel unit comprises a data switch 171 and a storage unit 173. In the following description, the process of writing a data signal into a sub-pixel unit means that the data signal is written into the storage unit of the sub-pixel unit.

The gate lines GL1 and GL2 are utilized for furnishing the gate signals SG1 and SG2 provided by the gate driver 130 to the corresponding data switches 171. The demultiplexer unit 140 distributes each data signal provided by the source driver 110 into one corresponding data line 160 based on the control signals CHK1-CHK3 generated by the control circuit 120. Each data line 160 is utilized for forwarding one corresponding data signal from the demultiplexer unit 140 to the corresponding sub-pixel units. Each data switch 171 controls the process of writing one corresponding data signal to one corresponding storage unit 173 based on one corresponding gate signal.

Please refer to FIG. 2 and FIG. 3. FIG. 2 shows the related signal waveforms regarding the dot-inversion driving operation of the LCD device in FIG. 1, having time along the abscissa. FIG. 3 presents a process list depicting the related writing operations of the LCD device in FIG. 1 based on the related signal waveforms in FIG. 2. The signal waveforms in FIG. 2, from top to bottom, are the gate signal SG1, the gate signal SG2, and the control signals CHK1-CHK3. Both the first interval and the second interval are within the same frame period. The dot-inversion driving operation of the LCD device 100 is summarized as the followings.

The gate signal SG1 is continuously enabled during the first interval. During the sub-interval Td1 of the first interval, the control signal CHK1 is enabled for turning on the switches SWR1 and SWR2 so that the data signal with positive polarity can be written into the red sub-pixel unit PR11 via the data line DLR1 and the data signal with negative polarity can be written into the red sub-pixel unit PR12 via the data line DLR2. During the sub-interval Td2 of the first interval, the control signal CHK2 is enabled for turning on the switches SWG1 and SWG2 so that the data signal with negative polarity can be written into the green sub-pixel unit PG11 via the data line DLG1 and the data signal with positive polarity can be written into the green sub-pixel unit PG12 via the data line DLG2. It is noted that the positive polarity means that the voltage of the corresponding data signal is positive with respect to the common voltage Vcom, and the negative polarity means that the voltage of the corresponding data signal is negative with respect to the common voltage Vcom.

The gate signal SG2 is continuously enabled during the second interval. During the sub-interval Td1 of the second interval, the control signal CHK1 is enabled for turning on the switches SWR1 and SWR2 so that the data signal with negative polarity can be written into the red sub-pixel unit PR21 via the data line DLR1 and the data signal with positive polarity can be written into the red sub-pixel unit PR22 via the data line DLR2. During the sub-interval Td2 of the second interval, the control signal CHK2 is enabled for turning on the switches SWG1 and SWG2 so that the data signal with positive polarity can be written into the green sub-pixel unit PG21 via the data line DLG1 and the data signal with negative polarity can be written into the green sub-pixel unit PG22 via the data line DLG2. The other related writing operations can be inferred accordingly.

In the aforementioned dot-inversion driving operation, the common voltage Vcom is a DC voltage, and therefore the voltage swings between data signals having different polarities are falling into a wide voltage range. Accordingly, the components installed in the prior-art LCD device should be compatible with the extensive voltage swing operation. That is, the components of the prior-art LCD device should be fabricated based on a costly High-Voltage IC fabrication process.

### SUMMARY OF THE INVENTION

In accordance with an embodiment of the present invention, a liquid crystal display device based on the dot-inversion or pixel-inversion driving operation is provided. The liquid crystal display device comprises a source driver, a gate driver, a plurality of data lines, a plurality of gate lines, a control circuit, and a plurality of demultiplexer modules.

The source driver is utilized for generating a plurality of data signals. The source driver comprises a plurality of output ports for outputting the data signals. The gate driver is utilized for generating a plurality of gate signals. The data lines comprise a plurality of first data lines and a plurality of second data lines. Each of the gate lines is coupled to the gate driver for receiving a corresponding gate signal. The control circuit is utilized for generating a plurality of first control signals and a plurality of second control signals. Each of the demultiplexer modules comprises a first demultiplexer and a second demultiplexer. The first demultiplexer is coupled to the control circuit, the source driver and the first data lines for distributing a first data signal of the data signals to the first data lines based on the first control signals. The second demultiplexer is coupled to the control circuit, the source driver and the second data lines for distributing a second data signal of the data signals to the second data lines based on the second control signals.

In accordance with another embodiment of the present invention, a driving method for use in an LCD device is provided. The driving method comprises setting a first gate signal to be an enabled signal during a first interval, setting a common voltage to be a first voltage during a first sub-interval of the first interval, and setting the common voltage to be a second voltage during a second sub-interval of the first interval.

Furthermore, the present invention provides a driving method for use in an LCD device. The driving method comprises setting a first gate signal to be an enabled signal during a first interval, setting a common voltage to be a first voltage and writing a first set of data signals with a first polarity sequentially into a first set of storage units of the LCD device based on the enabled first gate signal during a first set of sub-intervals of the first interval, and setting the common voltage to be a second voltage and writing a second set of data signals with a second polarity sequentially into a second set of storage units of the LCD device based on the enabled first gate signal during a second set of sub-intervals of the first interval. The first voltage is different from the second voltage, the first set of sub-intervals and the second set of sub-intervals are not overlapped, and the first polarity is opposite to the second polarity.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram showing a prior-art LCD device based on the dot-inversion driving operation.

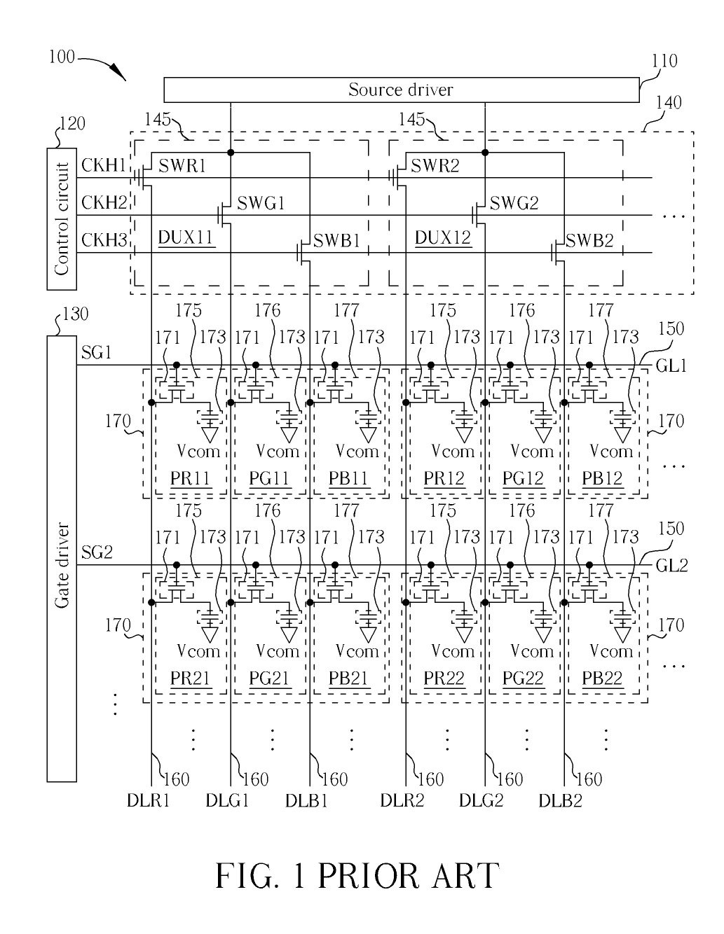

FIG. 2 shows the related signal waveforms regarding the dot-inversion driving operation of the LCD device in FIG. 1, having time along the abscissa.

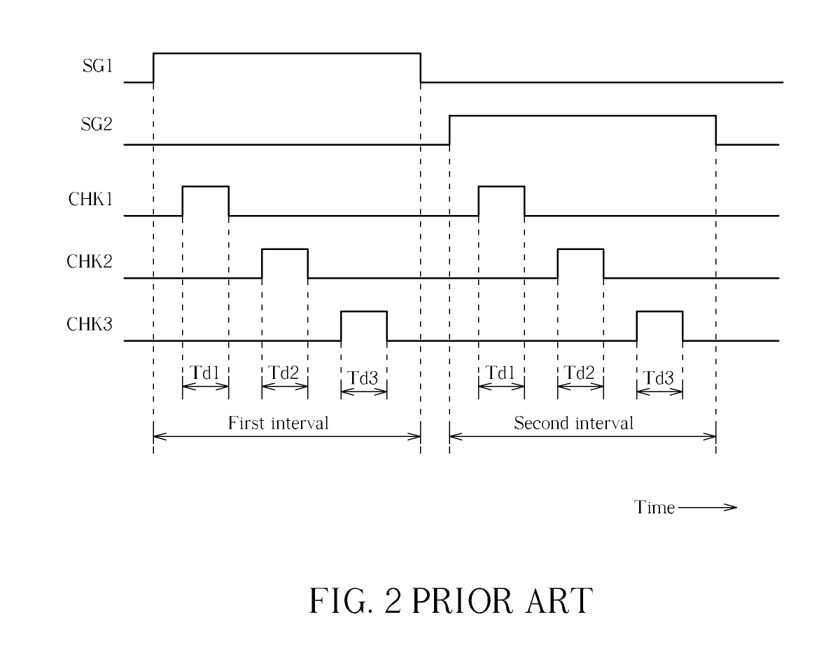

FIG. 3 presents a process list depicting the related writing operations of the LCD device in FIG. 1 based on the related signal waveforms in FIG. 2.

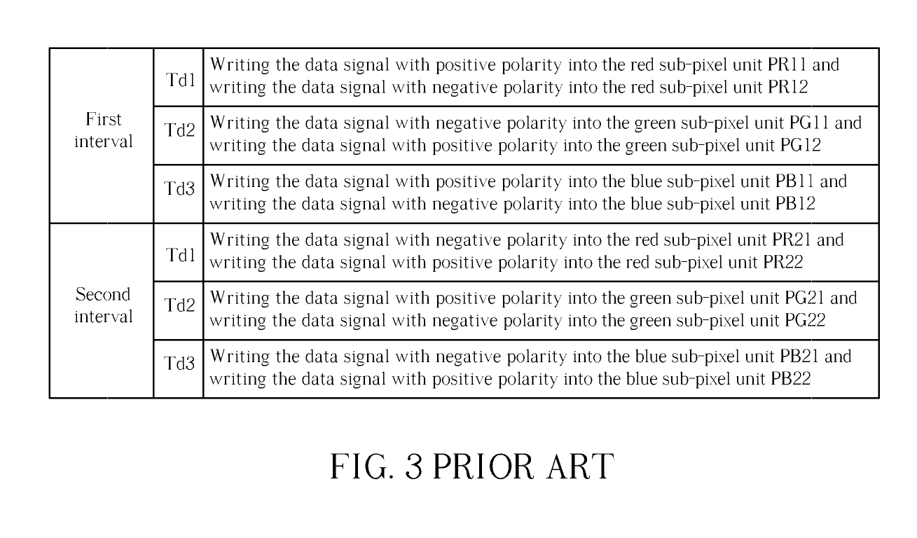

FIG. 4 is a schematic diagram showing an LCD device based on the dot-inversion or pixel-inversion driving operation in accordance with an embodiment of the present invention.

FIG. 5 shows the related signal waveforms regarding the pixel-inversion driving operation of the LCD device in FIG. 4, having time along the abscissa.

FIG. 6 presents a process list depicting the related writing operations of the LCD device in FIG. 4 based on the related signal waveforms in FIG. 5.

FIG. 7 shows the related signal waveforms regarding the dot-inversion driving operation of the LCD device in FIG. 4, having time along the abscissa.

FIG. 8 presents a process list depicting the related writing operations of the LCD device in FIG. 4 based on the related signal waveforms in FIG. 7.

### DETAILED DESCRIPTION

Hereinafter, preferred embodiments of the present invention will be described in detail with reference to the accompanying drawings. Here, it is to be noted that the present invention is not limited thereto.

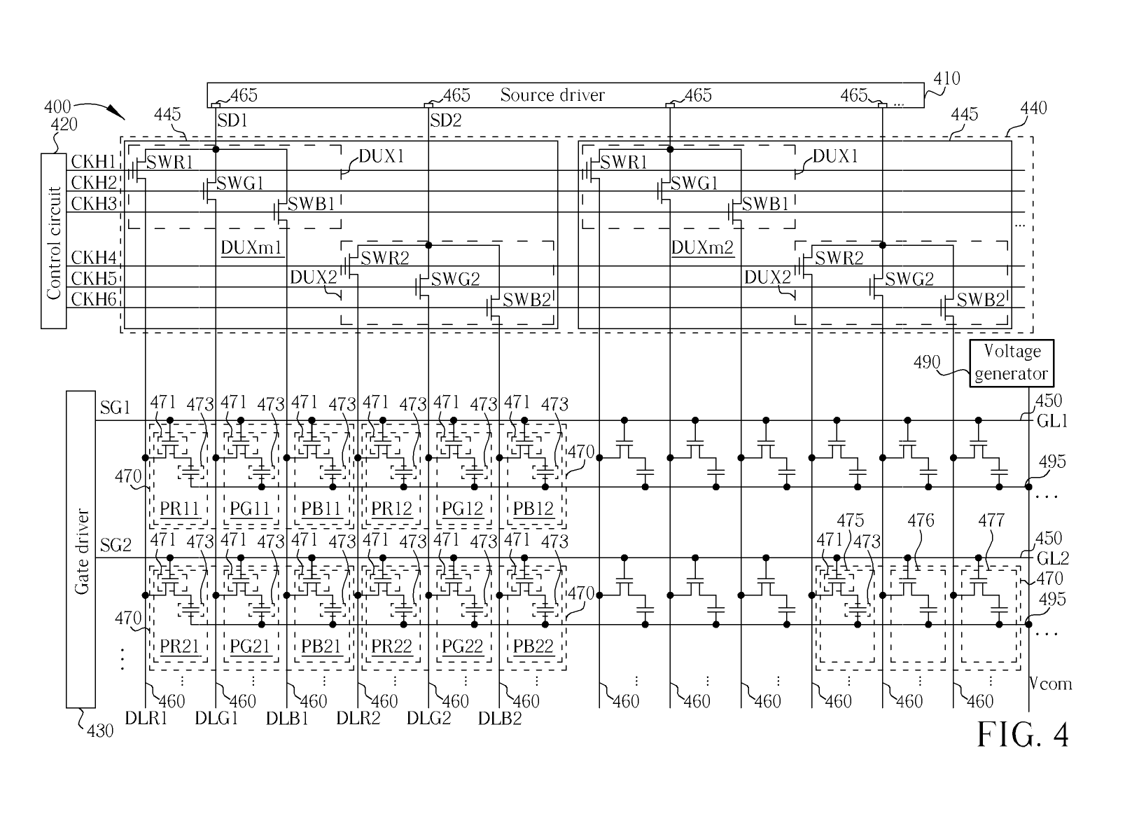

Please refer to FIG. 4, which is a schematic diagram showing an LCD device based on the dot-inversion or pixel-inversion driving operation in accordance with an embodiment of the present invention. As shown in FIG. 4, the LCD device 400 comprises a source driver 410, a control circuit 420, a gate driver 430, a voltage generator 490, a demultiplexer unit 440, a plurality of data lines 460, a plurality of gate lines 450, a plurality of common lines 495, and a plurality of pixel units 470. The demultiplexer unit 440 comprises a plurality of demultiplexer module 445. For ease of explanation, two demultiplexer modules DUXm1 and DUXm2 are shown in FIG. 4. Each demultiplexer module 445 comprises a first demultiplexer DUX1 and a second demultiplexer DUX2. The source driver 410 comprises a plurality of output ports 465 coupled to the demultiplexer unit 440. The voltage generator 490 is utilized for providing a common voltage Vcom to the common lines 495.

Each pixel unit 470 comprises a red sub-pixel unit 475, a green sub-pixel unit 476 and a blue sub-pixel unit 477. Each sub-pixel unit comprises a data switch 471 and a storage unit 473. Each storage unit 473 comprises a first end coupled to one corresponding common line 495, and a second end coupled to one corresponding data switch 471. Each data switch 471 comprises a first end coupled to the second end of one corresponding storage unit 473, a second end coupled to one corresponding data line 460, and a gate coupled to one corresponding gate line 450. The data switches 471 can be thin film transistors or metal-oxide-semiconductor (MOS) field effect transistors. Each storage unit 473 comprises at least one liquid crystal capacitor and at least one storage capacitor.

The control circuit 420 is utilized for generating a first set of control signals CHK1-CHK3 and a second set of control signals CHK4-CHK6. The first demultiplexer DUX1 comprises three switches SWR1, SWG1 and SWB1. Also, the second demultiplexer DUX2 comprises three switches SWR2, SWG2 and SWB2. The switches SWR1-SWB2 can be thin film transistors or MOS field effect transistors.

The switch SWR1 comprises a first end coupled to one corresponding output port 465 of the source driver 410, a second end coupled to one corresponding data line 460, and a control end coupled to the control circuit 420 for receiving the control signal CHK1. The signal connection between the first and second ends of the switch SWR1 is controlled based on the control signal CHK1 furnished to the control end of the switch SWR1. The switch SWR2 comprises a first end coupled to one corresponding output port 465 of the source driver 410, a second end coupled to one corresponding data line 460, and a control end coupled to the control circuit 420 for receiving the control signal CHK4. The signal connection between the first and second ends of the switch SWR2 is controlled based on the control signal CHK4 furnished to the control end of the switch SWR2. The functionalities and coupling relationships of the other switches can be inferred accordingly according to the above description on the switch SWR1 or the switch SWR2.

The source driver 410 outputs a plurality of data signals, e.g. SD1 and SD2, via the output ports 465. The first demultiplexer DUX1 of the demultiplexer module DUXm1 distributes the data signal SD1 into one of the data lines DLR1, DLG1 and DLB1 based on the switches SWR1, SWG1 and SWB1 controlled by the first set of control signals CHK1-CHK3. For instance, when the control signal CHK2 is enabled, the data signal SD1 is forwarded to the data line DLG1 via the switch SWG1 of the demultiplexer module DUXm1. Alternatively, when the control signal CHK3 is enabled, the data signal SD1 is forwarded to the data line DLB1 via the switch SWB1 of the demultiplexer module DUXm1.

The second demultiplexer DUX2 of the demultiplexer module DUXm1 distributes the data signal SD2 into one of the data lines DLR2, DLG2 and DLB2 based on the switches SWR2, SWG2 and SWB2 controlled by the second set of control signals CHK4-CHK6. For instance, when the control signal CHK5 is enabled, the data signal SD2 is forwarded to the data line DLG2 via the switch SWG2 of the demultiplexer module DUXm1. Alternatively, when the control signal CHK6 is enabled, the data signal SD2 is forwarded to the data line DLB2 via the switch SWB2 of the demultiplexer module DUXm1.

Each data line 460 is utilized for forwarding one corresponding data signal from the demultiplexer unit 440 to the corresponding sub-pixel units. Each data switch 471 controls the process of writing one corresponding data signal to one corresponding storage unit 473 based on one corresponding gate signal.

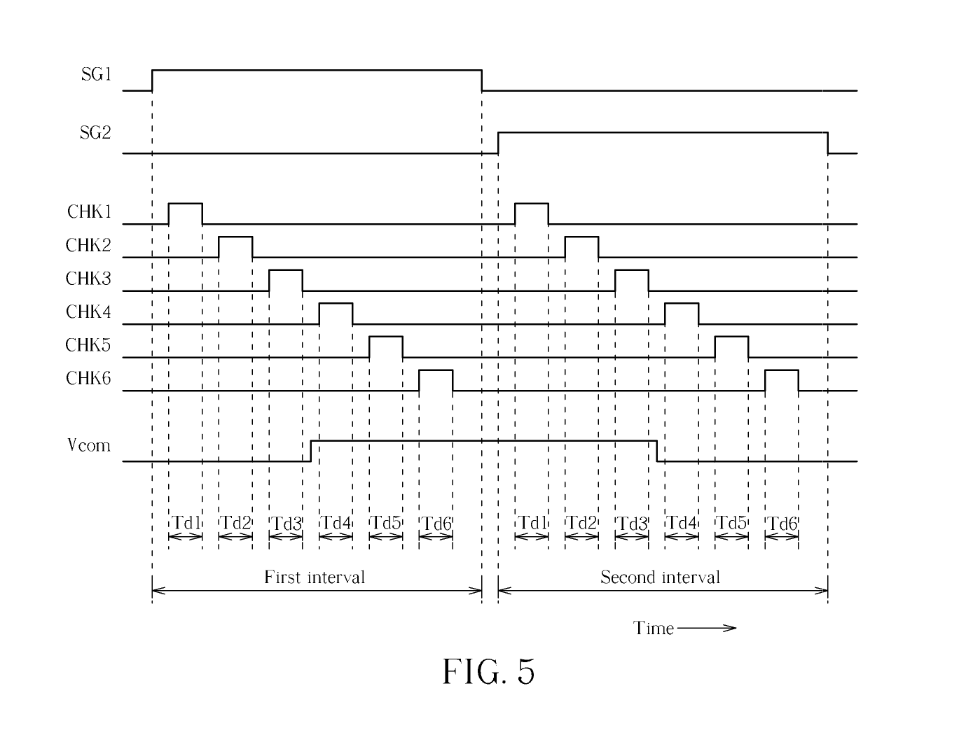

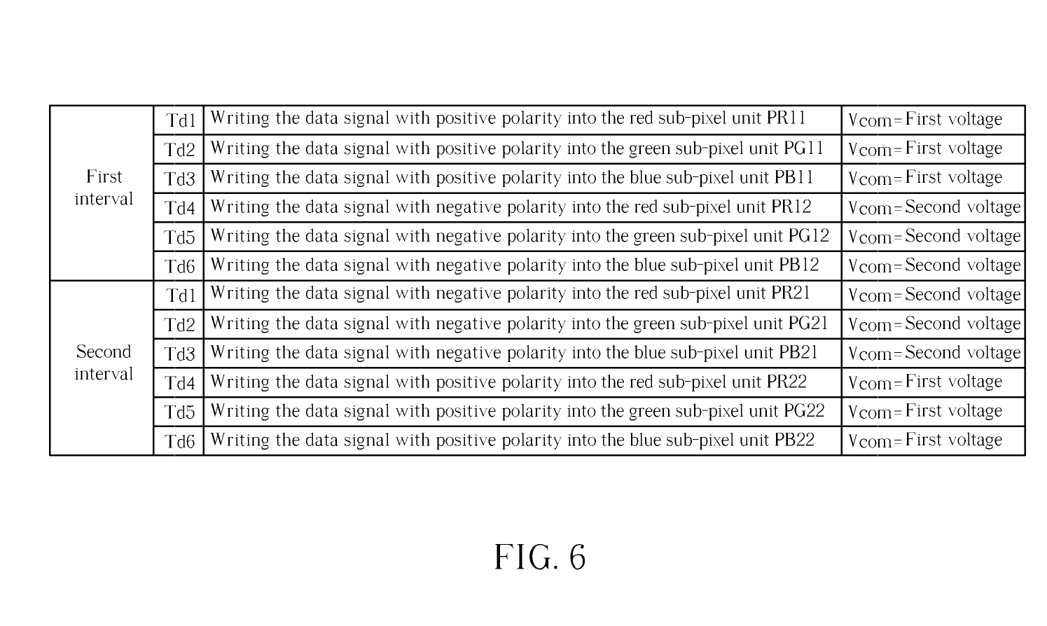

Please refer to FIG. 5 and FIG. 6. FIG. 5 shows the related signal waveforms regarding the pixel-inversion driving operation of the LCD device in FIG. 4, having time along the abscissa. FIG. 6 presents a process list depicting the related writing operations of the LCD device in FIG. 4 based on the related signal waveforms in FIG. 5. The signal waveforms in FIG. 5, from top to bottom, are the gate signal SG1, the gate signal SG2, the control signals CHK1-CHK6, and the common voltage Vcom. Both the first interval and the second interval are within the same frame period. The interval within which one corresponding gate signal is continuously enabled, e.g. the first interval or the second interval, is defined as a line time. Each line time comprises a plurality of sub-intervals Td1-Td6. The process of writing one corresponding data signal to one corresponding sub-pixel unit is carried out during one corresponding sub-interval. As shown in FIG. 5 and FIG. 6, the voltage of the common voltage Vcom is different between the sub-intervals Td1-Td3 and the sub-intervals Td4-Td6 within each line time. For instance, the common voltage Vcom is set to be a first voltage, e.g. a low voltage in the embodiment, during the sub-intervals Td1-Td3 of the first interval and during the sub-intervals Td4-Td6 of the second interval. Besides, the common voltage Vcom is set to be a second voltage, e.g. a high voltage in the embodiment, during the sub-intervals Td4-Td6 of the first interval and during the sub-intervals Td1-Td3 of the second interval. The pixel-inversion driving operation of the LCD device 400 is detailed as the followings.

The gate signal SG1 is an enabled signal having high voltage level and the gate signal SG2 is a disabled signal having low voltage level during the first interval. That is, the gate signal SG1 is continuously enabled during the corresponding line time. During the sub-interval Td1 of the first interval, the control signal CHK1 is enabled for turning on the switch SWR1 of the demultiplexer module DUXm1 so that the data signal SD1 with positive polarity can be written into the red sub-pixel unit PR11 via the data line DLR1. During the sub-interval Td2 of the first interval, the control signal CHK2 is enabled for turning on the switch SWG1 of the demultiplexer module DUXm1 so that the data signal SD1 with positive polarity can be written into the green sub-pixel unit PG11 via the data line DLG1. During the sub-interval Td3 of the first interval, the control signal CHK3 is enabled for turning on the switch SWB1 of the demultiplexer module DUXm1 so that the data signal SD1 with positive polarity can be written into the blue sub-pixel unit PB11 via the data line DLB1.

During the sub-interval Td4 of the first interval, the control signal CHK4 is enabled for turning on the switch SWR2 of the demultiplexer module DUXm1 so that the data signal SD2 with negative polarity can be written into the red sub-pixel unit PR12 via the data line DLR2. During the sub-interval Td5 of the first interval, the control signal CHK5 is enabled for turning on the switch SWG2 of the demultiplexer module DUXm1 so that the data signal SD2 with negative polarity can be written into the green sub-pixel unit PG12 via the data line DLG2. During the sub-interval Td6 of the first interval, the control signal CHK6 is enabled for turning on the switch SWB2 of the demultiplexer module DUXm1 so that the data signal SD2 with negative polarity can be written into the blue sub-pixel unit PB12 via the data line DLB2.

The gate signal SG2 is an enabled signal having high voltage level and the gate signal SG1 is a disabled signal having low voltage level during the second interval. That is, the gate signal SG2 is continuously enabled during the corresponding line time. During the sub-interval Td1 of the second interval, the control signal CHK1 is enabled for turning on the switch SWR1 of the demultiplexer module DUXm1 so that the data signal SD1 with negative polarity can be written into the red sub-pixel unit PR21 via the data line DLR1. During the sub-interval Td2 of the second interval, the control signal CHK2 is enabled for turning on the switch SWG1 of the demultiplexer module DUXm1 so that the data signal SD1 with negative polarity can be written into the green sub-pixel unit PG21 via the data line DLG1. During the sub-interval Td3 of the second interval, the control signal CHK3 is enabled for turning on the switch SWB1 of the demultiplexer module DUXm1 so that the data signal SD1 with negative polarity can be written into the blue sub-pixel unit PB21 via the data line DLB1.

During the sub-interval Td4 of the second interval, the control signal CHK4 is enabled for turning on the switch SWR2 of the demultiplexer module DUXm1 so that the data signal SD2 with positive polarity can be written into the red sub-pixel unit PR22 via the data line DLR2. During the sub-interval Td5 of the second interval, the control signal CHK5 is enabled for turning on the switch SWG2 of the demultiplexer module DUXm1 so that the data signal SD2 with positive polarity can be written into the green sub-pixel unit PG22 via the data line DLG2. During the sub-interval Td6 of the second interval, the control signal CHK6 is enabled for turning on the switch SWB2 of the demultiplexer module DUXm1 so that the data signal SD2 with positive polarity can be written into the blue sub-pixel unit PB22 via the data line DLB2.

In another embodiment concerning the pixel-inversion driving operation of the LCD device 400, the first and second voltages of the common voltage Vcom can be set to be the high and low voltages respectively, and the polarities of the written data signals corresponding to the first and second voltages of the common voltage Vcom are negative and positive respectively. In summary, the pixel-inversion driving operation of the LCD device 400 takes advantage of AC common voltage for reducing voltage swing between positive-polarity and negative-polarity data signals so that the power consumption concerning polarity switching can be reduced. Furthermore, the elements having low rated voltage can be installed in the LCD device 400 for performing the pixel-inversion driving operation for saving production cost.

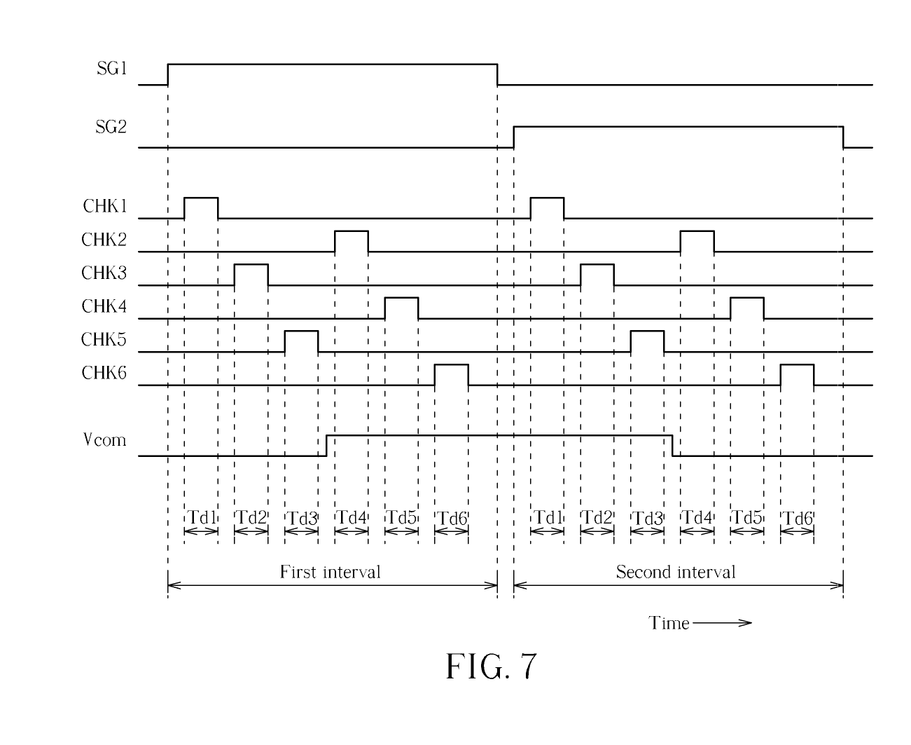

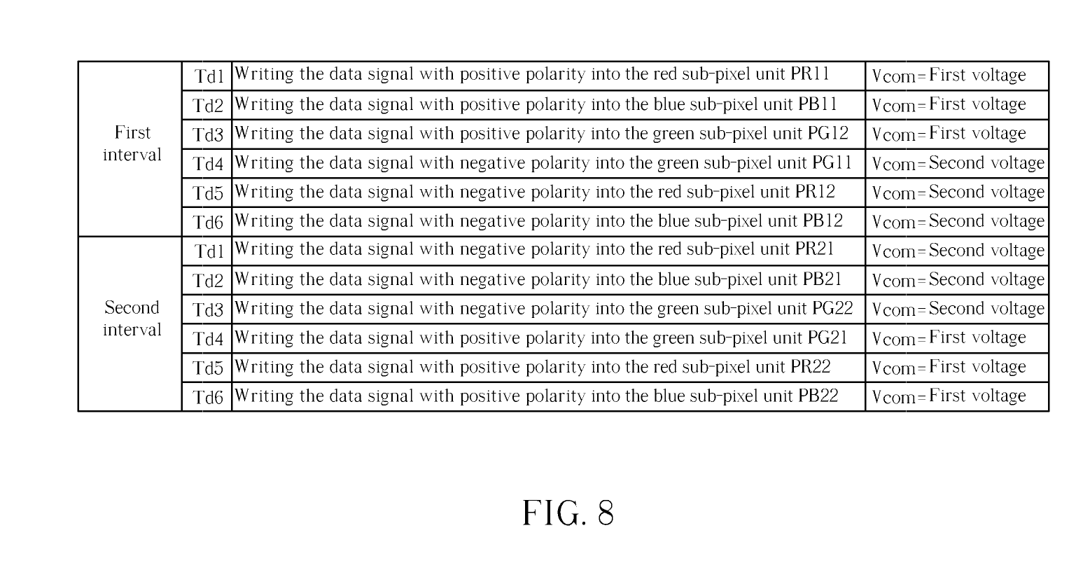

Please refer to FIG. 7 and FIG. 8. FIG. 7 shows the related signal waveforms regarding the dot-inversion driving operation of the LCD device in FIG. 4, having time along the abscissa. FIG. 8 presents a process list depicting the related writing operations of the LCD device in FIG. 4 based on the related signal waveforms in FIG. 7. The signal waveforms in FIG. 7, from top to bottom, are the gate signal SG1, the gate signal SG2, the control signals CHK1-CHK6, and the common voltage Vcom. Both the first interval and the second interval are within the same frame period. Each interval, i.e. a corresponding line time, comprises a plurality of sub-intervals Td1-Td6. The process of writing one corresponding data signal to one corresponding sub-pixel unit is carried out during one corresponding sub-interval. As shown in FIG. 7 and FIG. 8, the common voltage Vcom is set to be a first voltage, e.g. a low voltage in the embodiment, during the sub-intervals Td1-Td3 of the first interval and during the sub-intervals Td4-Td6 of the second interval. Besides, the common voltage Vcom is set to be a second voltage, e.g. a high voltage in the embodiment, during the sub-intervals Td4-Td6 of the first interval and during the sub-intervals Td1-Td3 of the second interval. The dot-inversion driving operation of the LCD device 400 is detailed as the followings.

The gate signal SG1 is an enabled signal having high voltage level and the gate signal SG2 is a disabled signal having low voltage level during the first interval. That is, the gate signal SG1 is continuously enabled during the corresponding line time. During the sub-interval Td1 of the first interval, the control signal CHK1 is enabled for turning on the switch SWR1 of the demultiplexer module DUXm1 so that the data signal SD1 with positive polarity can be written into the red sub-pixel unit PR11 via the data line DLR1. During the sub-interval Td2 of the first interval, the control signal CHK3 is enabled for turning on the switch SWB1 of the demultiplexer module DUXm1 so that the data signal SD1 with positive polarity can be written into the blue sub-pixel unit PB11 via the data line DLB1. During the sub-interval Td3 of the first interval, the control signal CHK5 is enabled for turning on the switch SWG2 of the demultiplexer module DUXm1 so that the data signal SD2 with positive polarity can be written into the green sub-pixel unit PG12 via the data line DLG2.

During the sub-interval Td4 of the first interval, the control signal CHK2 is enabled for turning on the switch SWG1 of the demultiplexer module DUXm1 so that the data signal SD1 with negative polarity can be written into the green sub-pixel unit PG11 via the data line DLG1. During the sub-interval Td5 of the first interval, the control signal CHK4 is enabled for turning on the switch SWR2 of the demultiplexer module DUXm1 so that the data signal SD2 with negative polarity can be written into the red sub-pixel unit PR12 via the data line DLR2. During the sub-interval Td6 of the first interval, the control signal CHK6 is enabled for turning on the switch SWB2 of the demultiplexer module DUXm1 so that the data signal SD2 with negative polarity can be written into the blue sub-pixel unit PB12 via the data line DLB2.

The gate signal SG2 is an enabled signal having high voltage level and the gate signal SG1 is a disabled signal having low voltage level during the second interval. That is, the gate signal SG2 is continuously enabled during the corresponding line time. During the sub-interval Td1 of the second interval, the control signal CHK1 is enabled for turning on the switch SWR1 of the demultiplexer module DUXm1 so that the data signal SD1 with negative polarity can be written into the red sub-pixel unit PR21 via the data line DLR1. During the sub-interval Td2 of the second interval, the control signal CHK3 is enabled for turning on the switch SWB1 of the demultiplexer module DUXm1 so that the data signal SD1 with negative polarity can be written into the blue sub-pixel unit PB21 via the data line DLB1. During the sub-interval Td3 of the second interval, the control signal CHK5 is enabled for turning on the switch SWG2 of the demultiplexer module DUXm1 so that the data signal SD2 with negative polarity can be written into the green sub-pixel unit PG22 via the data line DLG2.

During the sub-interval Td4 of the second interval, the control signal CHK2 is enabled for turning on the switch SWG1 of the demultiplexer module DUXm1 so that the data signal SD1 with positive polarity can be written into the green sub-pixel unit PG21 via the data line DLG1. During the sub-interval Td5 of the second interval, the control signal CHK4 is enabled for turning on the switch SWR2 of the demultiplexer module DUXm1 so that the data signal SD2 with positive polarity can be written into the red sub-pixel unit PR22 via the data line DLR2. During the sub-interval Td6 of the second interval, the control signal CHK6 is enabled for turning on the switch SWB2 of the demultiplexer module DUXm1 so that the data signal SD2 with positive polarity can be written into the blue sub-pixel unit PB22 via the data line DLB2.

In another embodiment concerning the dot-inversion driving operation of the LCD device 400, the first and second voltages of the common voltage Vcom can be set to be the high and low voltages respectively, and the polarities of the written data signals corresponding to the first and second voltages of the common voltage Vcom are negative and positive respectively. In summary, the dot-inversion driving operation of the LCD device 400 takes advantage of AC common voltage for reducing voltage swing between positive-polarity and negative-polarity data signals so that the power consumption concerning polarity switching can be reduced. Furthermore, the elements having low rated voltage can be installed in the LCD device 400 for performing the dot-inversion driving operation for saving production cost.

The present invention is by no means limited to the embodiments as described above by referring to the accompanying drawings, which may be modified and altered in a variety of different ways without departing from the scope of the present invention. Thus, it should be understood by those skilled in the art that various modifications, combinations, sub-combinations and alternations might occur depending on design requirements and other factors insofar as they are within the scope of the appended claims or the equivalents thereof.

What is claimed is:

1. A liquid crystal display device comprising:
a source driver for generating a plurality of data signals, the source driver comprising a plurality of output ports for outputting the data signals;
a gate driver for generating a plurality of gate signals;
a plurality of data lines, the data lines comprising a plurality of first data lines and a plurality of second data lines;
a plurality of gate lines, each of the gate lines being coupled to the gate driver for receiving a corresponding gate signal;
a control circuit for generating a plurality of first control signals and a plurality of second control signals; and
a plurality of demultiplexer modules, each of the demultiplexer modules comprising:
a first demultiplexer coupled to the control circuit, the source driver and the first data lines for distributing a first data signal of the data signals to the first data lines based on the first control signals; and
a second demultiplexer coupled to the control circuit, the source driver and the second data lines for distributing a second data signal of the data signals to the second data lines based on the second control signals.

2. The liquid crystal display device of claim 1, wherein the first demultiplexer comprises a plurality of switches, each of the switches comprises:
a first end coupled to a corresponding output port of the output ports of the source driver;
a second end coupled to a corresponding data line of the first data lines; and
a control end coupled to the control circuit for receiving a corresponding control signal of the first control signals, wherein the switch controls a signal connection between the first and second ends of the switch based on the corresponding control signal furnished to the control end of the switch;
wherein the switches are thin film transistors or MOS field effect transistors.

3. The liquid crystal display device of claim 1, wherein the second demultiplexer comprises a plurality of switches, each of the switches comprises:
a first end coupled to a corresponding output port of the output ports of the source driver;
a second end coupled to a corresponding data line of the second data lines; and
a control end coupled to the control circuit for receiving a corresponding control signal of the second control signals, wherein the switch controls a signal connection between the first end and the second end of the switch based on the corresponding control signal furnished to the control end of the switch;
wherein the switches are thin film transistors or MOS field effect transistors.

4. The liquid crystal display device of claim 1, further comprising:
a plurality of storage units, each of the storage units comprising:
a first end coupled to a corresponding data line of the data lines; and
a second end for receiving a common voltage.

5. The liquid crystal display device of claim 4, further comprising:
a plurality of common lines, each of the common lines coupled to a plurality of corresponding storage units of the storage units; and
a voltage generator coupled to the common lines for providing the common voltage.

6. A driving method for use in an LCD device, comprising:
setting a first gate signal to be an enabled signal during a first interval;
setting a common voltage to be a first voltage during a first sub-interval of the first interval; and
setting the common voltage to be a second voltage during a second sub-interval of the first interval.

7. The driving method of claim 6, further comprising:
setting the first gate signal to be a disabled signal during a second interval;
setting the common voltage to be the second voltage during a first sub-interval of the second interval; and
setting the common voltage to be the first voltage during a second sub-interval of the second interval.

8. The driving method of claim 6, wherein the first interval is corresponding to a line time.

9. A driving method for use in an LCD device, comprising:
setting a first gate signal to be an enabled signal during a first interval;
setting a common voltage to be a first voltage and writing a first set of data signals with a first polarity sequentially into a first set of storage units of the LCD device based on the enabled first gate signal during a first set of sub-intervals of the first interval; and
setting the common voltage to be a second voltage and writing a second set of data signals with a second polarity sequentially into a second set of storage units of the LCD device based on the enabled first gate signal during a second set of sub-intervals of the first interval;
wherein the first voltage is different from the second voltage, the first set of sub-intervals and the second set of sub-intervals are not overlapped, and the first polarity is opposite to the second polarity.

10. The driving method of claim 9, wherein:
setting the common voltage to be the first voltage and writing the first set of data signals with the first polarity sequentially into the first set of storage units of the LCD device based on the enabled first gate signal during the first set of sub-intervals of the first interval comprises:
setting the common voltage to be the first voltage and writing a first data signal with the first polarity into a first storage unit of the LCD device based on the enabled first gate signal during a first sub-interval of the first interval;
setting the common voltage to be the first voltage and writing a second data signal with the first polarity into a second storage unit of the LCD device based on the enabled first gate signal during a second sub-interval of the first interval; and
setting the common voltage to be the first voltage and writing a third data signal with the first polarity into a third storage unit of the LCD device based on the enabled first gate signal during a third sub-interval of the first interval; and
setting the common voltage to be the second voltage and writing the second set of data signals with the second polarity sequentially into the second set of storage units of the LCD device based on the enabled first gate signal during the second set of sub-intervals of the first interval comprises:
setting the common voltage to be the second voltage and writing a fourth data signal with the second polarity into a fourth storage unit of the LCD device based on the enabled first gate signal during a fourth sub-interval of the first interval;
setting the common voltage to be the second voltage and writing a fifth data signal with the second polarity into a fifth storage unit of the LCD device based on the enabled first gate signal during a fifth sub-interval of the first interval; and
setting the common voltage to be the second voltage and writing a sixth data signal with the second polarity into a sixth storage unit of the LCD device based on the enabled first gate signal during a sixth sub-interval of the first interval;
wherein the first, second and third sub-intervals are not overlapped between each other, and the fourth, fifth and sixth sub-intervals are not overlapped between each other.

11. The driving method of claim 10, wherein:
writing the first data signal with the first polarity into the first storage unit of the LCD device is writing the first data signal with the first polarity into the first storage unit of the LCD device via a first demultiplexer of the LCD device;
writing the second data signal with the first polarity into the second storage unit of the LCD device is writing the second data signal with the first polarity into the second storage unit of the LCD device via the first demultiplexer;
writing the third data signal with the first polarity into the third storage unit of the LCD device is writing the third data signal with the first polarity into the third storage unit of the LCD device via the first demultiplexer;
writing the fourth data signal with the second polarity into the fourth storage unit of the LCD device is writing the fourth data signal with the second polarity into the fourth storage unit of the LCD device via a second demultiplexer of the LCD device;
writing the fifth data signal with the second polarity into the fifth storage unit of the LCD device is writing the fifth data signal with the second polarity into the fifth storage unit of the LCD device via the second demultiplexer; and
writing the sixth data signal with the second polarity into the sixth storage unit of the LCD device is writing the sixth data signal with the second polarity into the sixth storage unit of the LCD device via the second demultiplexer.

12. The driving method of claim 10, wherein:
setting the common voltage to be the first voltage and writing the first data signal with the first polarity into the first storage unit of the LCD device based on the enabled first gate signal is setting the common voltage to be a low voltage and writing the first data signal with positive polarity into the first storage unit of the LCD device based on the enabled first gate signal;
setting the common voltage to be the first voltage and writing the second data signal with the first polarity into the second storage unit of the LCD device based on the enabled first gate signal is setting the common voltage to be the low voltage and writing the second data signal with positive polarity into the second storage unit of the LCD device based on the enabled first gate signal;
setting the common voltage to be the first voltage and writing the third data signal with the first polarity into the third storage unit of the LCD device based on the enabled first gate signal is setting the common voltage to be the low voltage and writing the third data signal with positive polarity into the third storage unit of the LCD device based on the enabled first gate signal;
setting the common voltage to be the second voltage and writing the fourth data signal with the second polarity into the fourth storage unit of the LCD device based on the enabled first gate signal is setting the common voltage to be a high voltage and writing the fourth data signal with negative polarity into the fourth storage unit of the LCD device based on the enabled first gate signal;
setting the common voltage to be the second voltage and writing the fifth data signal with the second polarity into the fifth storage unit of the LCD device based on the enabled first gate signal is setting the common voltage to be the high voltage and writing the fifth data signal with negative polarity into the fifth storage unit of the LCD device based on the enabled first gate signal; and
setting the common voltage to be the second voltage and writing the sixth data signal with the second polarity into the sixth storage unit of the LCD device based on the enabled first gate signal is setting the common voltage to be the high voltage and writing the sixth data signal with negative polarity into the sixth storage unit of the LCD device based on the enabled first gate signal.

13. The driving method of claim 10, further comprising:
setting a second gate signal to be an enabled signal during a second interval;
setting the common voltage to be the second voltage and writing a seventh data signal with the second polarity into a seventh storage unit of the LCD device based on the enabled second gate signal during a first sub-interval of the second interval;
setting the common voltage to be the second voltage and writing an eighth data signal with the second polarity into an eighth storage unit of the LCD device based on the enabled second gate signal during a second sub-interval of the second interval; and
setting the common voltage to be the second voltage and writing a ninth data signal with the second polarity into a ninth storage unit of the LCD device based on the enabled second gate signal during a third sub-interval of the second interval;
setting the common voltage to be the first voltage and writing a tenth data signal with the first polarity into a tenth storage unit of the LCD device based on the enabled second gate signal during a fourth sub-interval of the second interval;
setting the common voltage to be the first voltage and writing an eleventh data signal with the first polarity into an eleventh storage unit of the LCD device based on the enabled second gate signal during a fifth sub-interval of the second interval; and
setting the common voltage to be the first voltage and writing a twelfth data signal with the first polarity into a twelfth storage unit of the LCD device based on the enabled second gate signal during a sixth sub-interval of the second interval;
wherein the first interval and the second interval are not overlapped, and the first through sixth sub-intervals of the second interval are not overlapped between each other.

14. The driving method of claim 13, wherein:
setting the first gate signal to be the enabled signal during the first interval is furnishing the first gate signal having a high voltage level to a first gate line during the first interval; and
setting the second gate signal to be the enabled signal during the second interval is furnishing the second gate signal having a high voltage level to a second gate line adjacent to the first gate line during the second interval.

15. The driving method of claim 14, wherein:
the first through sixth storage units are coupled to the first gate line;
the seventh through twelfth storage units are coupled to the second gate line;
the first, second and third storage units are corresponding to a first pixel unit;
the fourth, fifth and sixth storage units are corresponding to a second pixel unit adjacent to the first pixel unit;
the seventh, eighth and ninth storage units are corresponding to a third pixel unit adjacent to the first pixel unit; and
the tenth, eleventh and twelfth storage units are corresponding to a fourth pixel unit adjacent to the second and third pixel units.

16. The driving method of claim 13, wherein:
writing the seventh data signal with the second polarity into the seventh storage unit of the LCD device is writing the seventh data signal with the second polarity into the seventh storage unit of the LCD device via a first demultiplexer of the LCD device;
writing the eighth data signal with the second polarity into the eighth storage unit of the LCD device is writing the eighth data signal with the second polarity into the eighth storage unit of the LCD device via the first demultiplexer;
writing the ninth data signal with the second polarity into the ninth storage unit of the LCD device is writing the ninth data signal with the second polarity into the ninth storage unit of the LCD device via the first demultiplexer;
writing the tenth data signal with the first polarity into the tenth storage unit of the LCD device is writing the tenth data signal with the first polarity into the tenth storage unit of the LCD device via a second demultiplexer of the LCD device;
writing the eleventh data signal with the first polarity into the eleventh storage unit of the LCD device is writing the eleventh data signal with the first polarity into the eleventh storage unit of the LCD device via the second demultiplexer; and
writing the twelfth data signal with the first polarity into the twelfth storage unit of the LCD device is writing the twelfth data signal with the first polarity into the twelfth storage unit of the LCD device via the second demultiplexer.

17. The driving method of claim 13, wherein:
setting the common voltage to be the second voltage and writing the seventh data signal with the second polarity into the seventh storage unit of the LCD device based on the enabled second gate signal is setting the common voltage to be a high voltage and writing the seventh data signal with negative polarity into the seventh storage unit of the LCD device based on the enabled second gate signal;
setting the common voltage to be the second voltage and writing the eighth data signal with the second polarity into the eighth storage unit of the LCD device based on the enabled second gate signal is setting the common voltage to be the high voltage and writing the eighth data signal with negative polarity into the eighth storage unit of the LCD device based on the enabled second gate signal;
setting the common voltage to be the second voltage and writing the ninth data signal with the second polarity into the ninth storage unit of the LCD device based on the enabled second gate signal is setting the common voltage to be the high voltage and writing the ninth data signal with negative polarity into the ninth storage unit of the LCD device based on the enabled second gate signal;
setting the common voltage to be the first voltage and writing the tenth data signal with the first polarity into the tenth storage unit of the LCD device based on the enabled second gate signal is setting the common voltage to be a low voltage and writing the tenth data signal with positive polarity into the tenth storage unit of the LCD device based on the enabled second gate signal;
setting the common voltage to be the first voltage and writing the eleventh data signal with the first polarity into the eleventh storage unit of the LCD device based on the enabled second gate signal is setting the common voltage to be the low voltage and writing the eleventh data signal with positive polarity into the eleventh storage unit of the LCD device based on the enabled second gate signal; and
setting the common voltage to be the first voltage and writing the twelfth data signal with the first polarity into the twelfth storage unit of the LCD device based on the enabled second gate signal is setting the common voltage to be the low voltage and writing the twelfth data signal with positive polarity into the twelfth storage unit of the LCD device based on the enabled second gate signal.

18. The driving method of claim 9, wherein:
setting the common voltage to be the first voltage and writing the first set of data signals with the first polarity sequentially into the first set of storage units of the LCD device based on the enabled first gate signal during the first set of sub-intervals of the first interval comprises:
setting the common voltage to be the first voltage and writing a first data signal with the first polarity into a first storage unit of the LCD device based on the enabled first gate signal during a first sub-interval of the first interval;
setting the common voltage to be the first voltage and writing a third data signal with the first polarity into a third storage unit of the LCD device based on the enabled first gate signal during a second sub-interval of the first interval; and
setting the common voltage to be the first voltage and writing a fifth data signal with the first polarity into a fifth storage unit of the LCD device based on the enabled first gate signal during a third sub-interval of the first interval; and
setting the common voltage to be the second voltage and writing the second set of data signals with the second polarity sequentially into the second set of storage units of the LCD device based on the enabled first gate signal during the second set of sub-intervals of the first interval comprises:
setting the common voltage to be the second voltage and writing a second data signal with the second polarity into a second storage unit of the LCD device based on the enabled first gate signal during a fourth sub-interval of the first interval;
setting the common voltage to be the second voltage and writing a fourth data signal with the second polarity into a fourth storage unit of the LCD device based on the enabled first gate signal during a fifth sub-interval of the first interval; and
setting the common voltage to be the second voltage and writing a sixth data signal with the second polarity into a sixth storage unit of the LCD device based on the enabled first gate signal during a sixth sub-interval of the first interval;
wherein the first, second and third sub-intervals are not overlapped between each other, and the fourth, fifth and sixth sub-intervals are not overlapped between each other.

19. The driving method of claim 18, wherein:
writing the first data signal with the first polarity into the first storage unit of the LCD device is writing the first data signal with the first polarity into the first storage unit of the LCD device via a first demultiplexer of the LCD device;
writing the third data signal with the first polarity into the third storage unit of the LCD device is writing the third data signal with the first polarity into the third storage unit of the LCD device via the first demultiplexer;
writing the fifth data signal with the first polarity into the fifth storage unit of the LCD device is writing the fifth data signal with the first polarity into the fifth storage unit of the LCD device via a second demultiplexer of the LCD device;
writing the second data signal with the second polarity into the second storage unit of the LCD device is writing the second data signal with the second polarity into the second storage unit of the LCD device via the first demultiplexer;
writing the fourth data signal with the second polarity into the fourth storage unit of the LCD device is writing the fourth data signal with the second polarity into the fourth storage unit of the LCD device via the second demultiplexer; and
writing the sixth data signal with the second polarity into the sixth storage unit of the LCD device is writing the sixth data signal with the second polarity into the sixth storage unit of the LCD device via the second demultiplexer.

20. The driving method of claim 18, wherein:
setting the common voltage to be the first voltage and writing the first data signal with the first polarity into the first storage unit of the LCD device based on the enabled first gate signal is setting the common voltage to be a low voltage and writing the first data signal with positive polarity into the first storage unit of the LCD device based on the enabled first gate signal;
setting the common voltage to be the first voltage and writing the third data signal with the first polarity into the third storage unit of the LCD device based on the enabled first gate signal is setting the common voltage to be the low voltage and writing the third data signal with positive polarity into the third storage unit of the LCD device based on the enabled first gate signal;
setting the common voltage to be the first voltage and writing the fifth data signal with the first polarity into the fifth storage unit of the LCD device based on the enabled first gate signal is setting the common voltage to be the low voltage and writing the fifth data signal with positive polarity into the fifth storage unit of the LCD device based on the enabled first gate signal;
setting the common voltage to be the second voltage and writing the second data signal with the second polarity into the second storage unit of the LCD device based on the enabled first gate signal is setting the common voltage to be a high voltage and writing the second data signal with negative polarity into the second storage unit of the LCD device based on the enabled first gate signal;
setting the common voltage to be the second voltage and writing the fourth data signal with the second polarity into the fourth storage unit of the LCD device based on the enabled first gate signal is setting the common voltage to be the high voltage and writing the fourth data signal with negative polarity into the fourth storage unit of the LCD device based on the enabled first gate signal; and
setting the common voltage to be the second voltage and writing the sixth data signal with the second polarity into the sixth storage unit of the LCD device based on the enabled first gate signal is setting the common voltage to be the high voltage and writing the sixth data signal with negative polarity into the sixth storage unit of the LCD device based on the enabled first gate signal.

21. The driving method of claim 18, further comprising:
setting a second gate signal to be an enabled signal during a second interval;
setting the common voltage to be the second voltage and writing a seventh data signal with the second polarity into a seventh storage unit of the LCD device based on the enabled second gate signal during a first sub-interval of the second interval;
setting the common voltage to be the second voltage and writing a ninth data signal with the second polarity into a ninth storage unit of the LCD device based on the enabled second gate signal during a second sub-interval of the second interval; and
setting the common voltage to be the second voltage and writing an eleventh data signal with the second polarity into an eleventh storage unit of the LCD device based on the enabled second gate signal during a third sub-interval of the second interval;
setting the common voltage to be the first voltage and writing an eighth data signal with the first polarity into an eighth storage unit of the LCD device based on the enabled second gate signal during a fourth sub-interval of the second interval;
setting the common voltage to be the first voltage and writing a tenth data signal with the first polarity into a tenth storage unit of the LCD device based on the enabled second gate signal during a fifth sub-interval of the second interval; and
setting the common voltage to be the first voltage and writing a twelfth data signal with the first polarity into a twelfth storage unit of the LCD device based on the enabled second gate signal during a sixth sub-interval of the second interval;
wherein the first interval and the second interval are not overlapped, and the first through sixth sub-intervals of the second interval are not overlapped between each other.

22. The driving method of claim 21, wherein:
setting the first gate signal to be the enabled signal during the first interval is furnishing the first gate signal having a high voltage level to a first gate line during the first interval; and
setting the second gate signal to be the enabled signal during the second interval is furnishing the second gate signal having a high voltage level to a second gate line adjacent to the first gate line during the second interval.

23. The driving method of claim 22, wherein:
the first through sixth storage units are coupled to the first gate line;
the seventh through twelfth storage units are coupled to the second gate line;
the first, second and third storage units are corresponding to a first pixel unit;
the fourth, fifth and sixth storage units are corresponding to a second pixel unit adjacent to the first pixel unit;
the seventh, eighth and ninth storage units are corresponding to a third pixel unit adjacent to the first pixel unit; and
the tenth, eleventh and twelfth storage units are corresponding to a fourth pixel unit adjacent to the second and third pixel units.

24. The driving method of claim 21, wherein:
writing the seventh data signal with the second polarity into the seventh storage unit of the LCD device is writing the seventh data signal with the second polarity into the seventh storage unit of the LCD device via a first demultiplexer of the LCD device;
writing the ninth data signal with the second polarity into the ninth storage unit of the LCD device is writing the ninth data signal with the second polarity into the ninth storage unit of the LCD device via the first demultiplexer;
writing the eleventh data signal with the second polarity into the eleventh storage unit of the LCD device is writing the eleventh data signal with the second polarity into the eleventh storage unit of the LCD device via a second demultiplexer of the LCD device;
writing the eighth data signal with the first polarity into the eighth storage unit of the LCD device is writing the eighth data signal with the first polarity into the eighth storage unit of the LCD device via the first demultiplexer of the LCD device;
writing the tenth data signal with the first polarity into the tenth storage unit of the LCD device is writing the tenth data signal with the first polarity into the tenth storage unit of the LCD device via the second demultiplexer; and
writing the twelfth data signal with the first polarity into the twelfth storage unit of the LCD device is writing the twelfth data signal with the first polarity into the twelfth storage unit of the LCD device via the second demultiplexer.

25. The driving method of claim 21, wherein:
setting the common voltage to be the second voltage and writing the seventh data signal with the second polarity into the seventh storage unit of the LCD device based on the enabled second gate signal is setting the common voltage to be a high voltage and writing the seventh data signal with negative polarity into the seventh storage unit of the LCD device based on the enabled second gate signal;
setting the common voltage to be the second voltage and writing the ninth data signal with the second polarity into the ninth storage unit of the LCD device based on the enabled second gate signal is setting the common voltage to be the high voltage and writing the ninth data signal with negative polarity into the ninth storage unit of the LCD device based on the enabled second gate signal;
setting the common voltage to be the second voltage and writing the eleventh data signal with the second polarity into the eleventh storage unit of the LCD device based on the enabled second gate signal is setting the common voltage to be the high voltage and writing the eleventh data signal with negative polarity into the eleventh storage unit of the LCD device based on the enabled second gate signal;
setting the common voltage to be the first voltage and writing the eighth data signal with the first polarity into the eighth storage unit of the LCD device based on the enabled second gate signal is setting the common voltage to be a low voltage and writing the eighth data signal with positive polarity into the eighth storage unit of the LCD device based on the enabled second gate signal;
setting the common voltage to be the first voltage and writing the tenth data signal with the first polarity into the tenth storage unit of the LCD device based on the enabled second gate signal is setting the common voltage to be the low voltage and writing the tenth data signal with positive polarity into the tenth storage unit of the LCD device based on the enabled second gate signal; and
setting the common voltage to be the first voltage and writing the twelfth data signal with the first polarity into the twelfth storage unit of the LCD device based on the enabled second gate signal is setting the common voltage to be the low voltage and writing the twelfth data signal with positive polarity into the twelfth storage unit of the LCD device based on the enabled second gate signal.
